(19) United States
(12) Patent Application Publication
(10) Pub. No.: US 2025/0356505 A1
(43) Pub. Date: Nov. 20, 2025

(54) METHOD FOR PREDICTING TRAJECTORIES OF OBJECTS

(71) Applicant: MERCEDES-BENZ GROUP AG, Stuttgart (DE)

(72) Inventors: Julian SCHMIDT, Steißlingen (DE); Franz GRITSCHNEDER, Esslingen (DE); Julian JORDAN, Tübingen (DE); Jan RUPPRECHT, Herrenberg (DE)

(21) Appl. No.: 18/854,734

(22) PCT Filed: Mar. 3, 2023
(86) PCT No.: PCT/EP2023/055517

§ 371 Date: Oct. 7, 2024

(30) Foreign Application Priority Data
Apr. 8, 2022 (DE) 10 2022 001 208.1

(51) Int. Cl. G06T 7/246; G06T 7/10; G06V 10/82; G06V 20/58

(52) U.S. Cl. CPC G06T 7/246; G06T 7/10; G06V 10/82; G06V 20/58; G06T 2207/20084; G06T 2207/30241; G06T 2207/30261

(57) ABSTRACT

Trajectories of objects in the surroundings of a vehicle are predicted using raw sensor data of the surroundings of the vehicle detected by environment sensors and are pre-processed in a plurality of successive time intervals in order to generate object hypotheses. Based on the object hypotheses, the raw sensor data is segmented and allocated to the respective object hypothesis. The raw sensor data belonging to the respective object hypothesis is converted into latent encodings and allocated to the respective object hypothesis as a feature. Object hypotheses merged by learning-based clusters are generated from the individual object hypotheses and the allocated features. Tracks of the respective merged object hypotheses are formed by learning-based allocations between the merged object hypotheses determined in a current time interval and the merged object hypotheses ascertained in several previous time intervals, being generated. Trajectories are predicted by the tracks for the respective merged object hypotheses.

### BACKGROUND AND SUMMARY OF THE INVENTION

Exemplary embodiments of the invention relate to a method for predicting trajectories of objects in the surroundings of a vehicle.

The prediction of vehicles participating in traffic forms an important component of autonomous vehicles. Reliable and safe movement planning is only possible when this prediction is also of high quality.

A method for driving an ego-vehicle with the following steps is known from DE 10 2019 215 147 A1:
Detecting an outer environment of the ego-vehicle and emitting environment information from the detected environment;
Neural network-based forecasting of trajectories of road users surrounding the ego-vehicle based on the emitted surroundings information;
Rule-based forecasting of the trajectories of the road users surrounding the ego-vehicle based on the emitted environment information;
Determining a collision risk of the ego-vehicle with the surrounding road users in each case for the neural network-based and rule-based forecasted trajectories;
Selecting the neural network-based or rule-based forecasted trajectory for the respective road user depending on the determined collision risks;
Providing an ego-trajectory for driving the ego-vehicle depending on the selected forecasted trajectories of the road users.

Furthermore, a method for tracking an object depending on sensor data of an environment sensor for an operation of a vehicle is known from DE 10 2019 216 290 A1. Here, the vehicle has the environment sensor, and the sensor data represents the surroundings of the vehicle detected by the environment sensor. The method comprises the following steps:
Selecting a partial amount of the sensor data depending on a current state of the tracked object;
Applying a method of machine learning to the selected partial amount of the sensor data in order to obtain information about the tracked object from the data;
Updating the current state of the tracked object depending on information obtained.

Exemplary embodiments of the invention are directed to a novel method for predicting trajectories of objects in the surroundings of a vehicle.

In a method according to the invention for predicting trajectories of objects in the surroundings of a vehicle, raw sensor data of the surroundings of the vehicle is detected by means of environmental sensors, wherein the raw sensor data is pre-processed in a plurality of successive time increments in order to generate object hypotheses for objects in the surroundings of the vehicle, wherein the raw sensor data is segmented based on the object hypotheses and allocated to the respective object hypothesis, wherein the raw sensor data belonging to the respective object hypothesis is converted into latent encodings by means of a learning-based encoder block and allocated to the respective object hypothesis as features, wherein object hypotheses merged by learning-based clusters from the individual object hypotheses and the allocated features in a fusion block are generated, wherein tracks of the respective merged object hypotheses are formed in a tracking block by learning-based allocations between the merged object hypotheses determined in a current time interval and the merged object hypotheses determined in the multiple previous time intervals being generated, wherein trajectories are predicted for the respective merged object hypotheses by means of the tracks.

Advantageously, the raw sensor data is detected for a plurality of environment sensors of several sensor modalities, pre-processed individually for each of the sensors and individually from this determines the latent encodings for each sensor.

In an embodiment, trajectories predicted for a future point in time of the merged object hypotheses are compared to real trajectories of the merged object hypotheses determined at the future point in time, in order to determine a prediction error, wherein the determined prediction error is propagated back to the encoder block, to the merging block and to the tracking block for training purposes.

In an embodiment, two or more from the group of camera, radar sensor, Lidar sensor and ultrasound sensor are used as sensor modalities.

In an embodiment, a transformer model, a recurrent neuronal network, or a graph neuronal network are used as the algorithm for the prediction of the trajectories.

In an embodiment, segmented raw sensor data of an object hypothesis of a camera with a convolutional neuronal network is converted into latent encodings, wherein the weightings in the convolutional neuronal network are learned.

In an embodiment, segmented raw sensor data of an object hypothesis of a Lidar senor with a PointNet is converted into latent encodings, wherein the weightings in the PointNet are learned.

In an embodiment, a paired measure of belonging between nodes in a graph is calculated for the learning-based formation of the merged object hypotheses, wherein a graph neuronal network is used for “link prediction” and/or edge classification, such that probabilities in pairs emerge of nodes belonging to the same object, wherein clusters of the individual nodes are formed by means of a standard clustering algorithm based on the measure of belonging.

In an alternative embodiment of the method, a learned graph clustering algorithm is used for the learning-based formation of the merged object hypotheses.

In an embodiment, the information of all nodes is aggregated for each cluster by means of pooling, such that an aggregated latent representation of the sensor data and an aggregated state is implemented per merged object hypothesis.

In an embodiment, a graph neuronal network is used for the “link prediction” and/or the edge classification for the tracking.

Learning-based methods for trajectory prediction have proved to be particularly accurate. The present invention introduces for the first time how merging, tracking, and prediction can be carried out in an end-to-end learned approach. The learned end-to-end approach ensures that relevant sensor information of individual object hypotheses can also be used for the prediction.

In known methods for trajectory prediction, which work on tracklets (temporal sequence of 2D x-y coordinates of the individual vehicles in a scene), the tracklets originate from an upstream stack, which already handles the perception, the tracking and the merging of the individual agents. The disadvantage of these approaches is that only the tracklets serve as input information for the prediction. In contrast to these approaches, as a result of the present solution according to the information, sensor-specific information (e.g. the color or the shape of a known vehicle) is not lost. This can thus be advantageous because a shape can definitely be relevant to the prediction: for example, sports cars can behave kinematically differently to classic family cars, which is why the presence of such information can also be advantageous in the prediction.

In other methods for trajectory prediction, which work on raw sensor data of an individual sensor modality, the object recognition and the prediction is learned end-to-end. The problem here is that these approaches are always limited to an individual sensor modality. This means that objects are often only recognized by means of a Lidar scanner and these are then tracked over time and predicted. In contrast to these approaches, as a result of the present solution according to the invention, important requests of autonomous systems are met by several sensor modalities (camera, Lidar, radar, ultrasound) being taken into consideration. All these sensor modalities generate valuable information which can be used simultaneously by means of the solution according to the invention.

The approach according to the invention makes it possible to use the detections by any number of independent sensor modalities and to merge these detections, to track them over time, and subsequently to generate predictions. The learning-based end-to-end approach here makes it possible for relevant sensor information (it is learnt which information is relevant to the predictions and how it is extracted) to also be available for the prediction.

The approach according to the invention allows an improvement of the trajectory prediction by using relevant sensor information in the form of a latent encoding. It is learned here as to what information is relevant, and is not determined by a metric generated by hand. A better prediction leads to the behavior of the autonomous vehicle being able to be better planned. The degree of driving comfort and safety are thus higher. The end-to-end approach avoids the training of individual components and can be trained as a whole. This saves training time. A use of the recognized objects of different sensor modalities is possible without problems. Furthermore, a scaling is possible with any number of sensors and with any sensor modalities.

Exemplary embodiments of the invention are described in more detail below by means of drawings.

### BRIEF DESCRIPTION OF THE DRAWING FIGURES

Here are shown:

FIG. 1, schematically, a flowchart of a method for predicting trajectories of objects in the surroundings of a vehicle,

FIG. 2, schematically, a flowchart of a method for predicting trajectories of objects in the surroundings of a vehicle, and

FIG. 3, schematically, a block wiring diagram of a system for predicting trajectories of objects in the surroundings of a vehicle.

Parts corresponding to one another are provided with the same reference numerals in all figures.

### DETAILED DESCRIPTION

Exemplary embodiments of the invention relate to a method for predicting trajectories of objects in the surroundings of a vehicle. The vehicle has a plurality of sensors for detecting surroundings, for example at least one camera, at least one radar sensor, at least one Lidar sensor and/or at least one ultrasound sensor. The invention assumes that the raw sensor data of the sensors is pre-processed. This pre-processing is carried out individually for each individual one of the sensors (sensor individual). Object hypotheses are generated in the pre-processing. An object hypothesis is a dataset including information about an object, the information having been extracted from the raw sensor data. Such information is, for example, information about the type of object (pedestrian, vehicle) and the state of the object (position of the object in a coordinate system common for all sensors, size of the object). A state vector and the raw sensor data are part of the object hypothesis.

Object hypotheses are determined, for example, from data detected by a camera, which comprise an image of the detected objects and a respective position of the respective object in a coordinate system. Object hypotheses are determined, for example, from data detected by a radar sensor, which comprise reflected points of the detection, the positions, and the speeds (due to the Doppler effect, radar also has the ability to measure speeds) of the detected objects in a coordinate system.

An object hypothesis correspondingly has, on one hand, the state vector (hereinafter referred to as state) containing information about the object hypothesis. The state contains at least the position and size of the object hypothesis (position and size of the object for which the object hypothesis is generated) in a uniform coordinate system. Depending on this, other sensor-specific variables can be part of the state of an object hypothesis. Radar detections can also have a speed, for example. In addition, the raw sensor data of the object is segmented based on the object hypothesis (and its size) and allocated to the respective object hypothesis. In the case of a camera or a Lidar sensor, for example, the pixels of a recognized vehicle would thus be extracted (semantic extraction of the pixels of the recognized vehicle).

This pre-processing is repeated at successive time intervals.

The raw sensor data belonging to the respective object hypothesis is converted into latent encodings by means of a learning-based encoder and allocated as a feature to the respective hypothesis.

Object hypotheses merged by (learning-based) clusters are generated from the individual object hypothesis and the allocated features.

In a further step, tracks of the respective merged object hypotheses are formed by (learning-based) allocations between the merged object hypotheses determined in a current time increment and the merged object hypotheses determined in several previous time increments being generated.

In a further step, trajectories are predicted for the respective merged object hypotheses by means of the tracks. The following come into question, for example, as algorithms for the prediction of the trajectories: transformer, RNN, GNN.

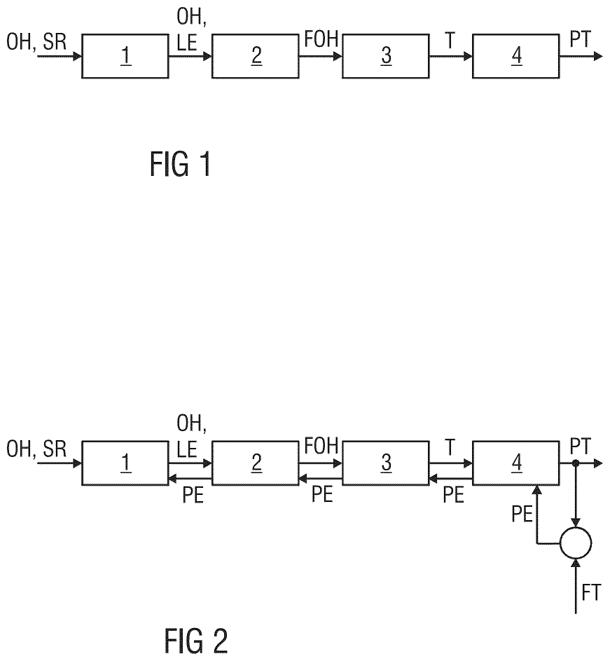

FIG. 1 is a schematic view of a flowchart of a method for predicting trajectories of objects in the surroundings of a vehicle.

In an encoder block 1, latent encodings LE are formed from the object hypotheses OH determined in the pre-processing and the allocated raw sensor data SR. Here, the latent encodings LE are formed for each of the object hypotheses OH determined in the current time interval and allocated to the respective object hypothesis OH as a feature. The latent encodings LE are values from a predetermined limited set of values. The raw sensor data SR is data from an unlimited set of values. Raw sensor data SR is thus mapped by the encoding from an unlimited set of values to a value from a limited set of values. For object hypotheses OH of a camera, the learning-based encoder block 1 can be formed as follows, for example: segmented raw sensor data SR of an object hypothesis OH of a camera can be converted into latent encodings LE using a convolutional neural network (CNN), for example. The weightings in the CNN are learned here. For object hypotheses OH of a Lidar sensor, the learning-based encoder block 1 can be formed as follows, for example: Segmented raw sensor data SR of an object hypothesis OH of a Lidar sensor can be converted into latent encodings LE using a PointNet, for example. The weightings in the PointNet are learned here.

This thus results in a state and a learned latent encoding LE for each object hypothesis OH at each time interval. The contents of these latent encodings LE cannot be interpreted by humans. It is a representation of the raw sensor data SR that the model has learned itself during training and is as suitable as possible.

In a merging block 2, the object hypotheses OH of all sensors formed in the current time interval are clustered by means of the latent encodings LE respectively allocated to them and merged object hypotheses FOH are formed. Here, a graph is created for each time interval. In this graph, all object hypotheses OH of the time interval are the nodes. Each node accordingly has a state vector and a latent encoding LE containing a learned and suitable representation of the sensor data. All nodes in the graph are connected to each other. It is thus a fully connected graph.

The merged object hypotheses FOH can be formed based on learning by clustering in the graph. Two variants can be used for this:
A paired measure of belonging between the nodes in the graph is calculated. This measure of belonging is learned. As also with the learning-based encoder block 1, the error measure required for this is only determined after the actual trajectory prediction and then propagated back to the determination of the measure of belonging. Due to the graph structure, graph neural networks can be used for “link prediction” and/or “edge classification”, for example. This results in probabilities in pairs that nodes belong to the same object. Based on the measure of belonging, clusters of the individual nodes can be formed by means of a standard clustering algorithm.
Alternatively, a learned graph clustering algorithm can also be used directly. In this alternative variant, the error measure required for this is also only determined after the actual trajectory prediction and then propagated back to the determination of the measure of belonging.

During the training process, the described learning-based clustering thus learns to assign object hypotheses OH to corresponding clusters in such a way that the error of the trajectory prediction is the lowest. This occurs when object hypotheses OH of several sensor modalities (e.g., camera and Lidar) belonging to the same real object are also assigned to the same cluster.

The information of all nodes is aggregated for each cluster (e.g., pooling). This corresponds to the merging of several object hypotheses OH into a merged object hypothesis FOH. This results in an aggregated latent representation of the sensor data and an aggregated state for each merged object hypothesis FOH. For the state, for example, averaging is conceivable as a type of aggregation.

In a tracking block 3, the merged object hypotheses FOH of the current time interval and the merged object hypotheses FOH determined in previous time intervals are analyzed. This involves determining across several time intervals which merged object hypotheses FOH of the previous time intervals belong to which of the merged object hypotheses FOH of the current time interval. The associated merged object hypotheses FOH from the different time intervals form tracks T of the respective merged object hypotheses FOH. A track T describes the temporal course of the respective merged object hypotheses FOH.

For tracking, a graph can be constructed that contains all merged object hypotheses FOH of the previous time intervals as nodes and all merged object hypotheses FOH of the current time interval as nodes. Feature vectors of the nodes are again the latent encodings LE and the state. In the graph, all nodes of two consecutive time intervals are connected to each other via edges. A measure of belonging is only determined for nodes that are connected to an edge. Once again, GNNs (Graph Neural Networks) can be used for “link prediction” and/or “edge classification”. For each node of the current time interval, the nodes of the previous time intervals with the highest measure of belonging can be determined. These nodes then belong to the track T of the same object. This results in a track T of merged object hypotheses FOH. This means that the merged object hypotheses FOH can be allocated to one another over several time intervals, resulting in tracklets. Accordingly, a track T is created to which the state of the respective merged object hypothesis FOH and its latent feature vector is also allocated at each time interval via the respective merged object hypothesis FOH.

In a prediction block 4, the trajectories PT of the merged object hypotheses FOH are predicted by means of their tracks T for time intervals in the future. This gives the predicted trajectories PT or tracks of the various merged hypotheses FOH.

The encoding in encoder block 1, the clustering in the merging block 2, and the formation of memberships in the tracking block 3 is carried out using learning algorithms. For the training, trajectories PT of the merged object hypotheses FOH are predicted for a future point in time, and the predictions are compared to true trajectories FT of the merged object hypotheses FOH determined at the future point in time in order to determine a prediction error PE. The determined prediction error PE is propagated back to encoder block 1, to the merging block 2 and to the tracking block 3 for training the algorithms. The algorithms in the encoder block 1, in the merging block 2 and in the tracking block 3 are thus simultaneously optimized end-to-end. Via the latent encoding LE, the trajectory prediction algorithm automatically has access to relevant sensor information that is propagated through the network.

FIG. 2 schematically shows a flowchart of the method for predicting trajectories of objects in the surroundings of a vehicle with the described back propagation of the prediction error PE. As already explained, the prediction error PE is determined by comparing the predicted trajectory PT and the true trajectory FT to each other. Carrying out this comparison is symbolized by a circle in the figure.

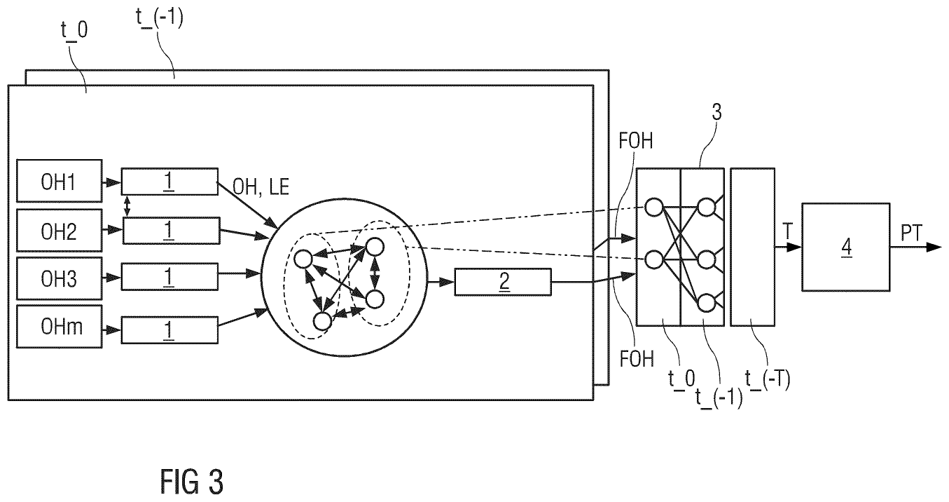

FIG. 3 schematically shows a block wiring diagram of a system for predicting trajectories PT of objects in the surroundings of a vehicle.

Object hypotheses OH1, OH2, OH3, OHm of different sensors are available as input values, which can be of the same or different sensor modality, for example camera, Lidar, radar and/or ultrasound. In a respective learning-based encoder block 1, latent encodings LE are formed from object hypotheses OH1 to Ohm, and the allocated raw sensor data SR for the current time interval t_0. Here, one and the same encoder block 1 can be used for object hypotheses OH1 to OHm of the same sensor modality, if necessary with split weights.

In a fusion block 2, the object hypotheses OH of all sensors formed in the current time interval t_0 are clustered by mean of the latent encodings LE allocated to them, and merged object hypotheses FOH are formed.

In a tracking block 3, the merged object hypotheses FOH of the current time interval t_0 and the merged object hypotheses FOH determined in previous time intervals t_(−1), t_(−T) are analyzed. The corresponding merged object hypotheses FOH from the different time intervals t_0, t_(−1), t_(−T) form tracks T of the respective merged object hypotheses FOH.

In a prediction block 4, the trajectories PT of the merged object hypotheses FOH are predicted for time intervals lying in the future by means of their tracks.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for predicting trajectories of objects in surroundings of a vehicle, the method comprising:
detecting, by environment sensors of the vehicle, raw sensor data of the surroundings of the vehicle;
pre-processing the raw sensor data in a plurality of successive time intervals to generate object hypotheses;
segmenting, based on the determined object hypotheses, the raw sensor data and allocating the segmented raw sensor data to a respective object hypothesis of the object hypotheses;
converting, by a learning-based encoder block, the raw sensor data belonging to the respective object hypothesis into latent encodings and the latent encodings are allocated to the respective object hypothesis as a feature;
generating, in a merging block and from the individual object hypotheses, object hypotheses merged by learning-based clusters are generated from the individual object hypotheses and the allocated features;
forming, in a tracking block, tracks of the respective merged object hypotheses by generating allocations between the merged object hypotheses determined in a current time interval and merged object hypotheses determined in several previous time intervals; and
predicting the trajectories of the objects using the formed tracks of the respective merged object hypotheses.

12. The method of claim 11, wherein the raw sensor data is recorded for a plurality of environment sensors of several sensor modalities, pre-processed individually for each of the plurality of environment sensors, and the latent encodings are determined from this individually for each of the plurality of environment sensors.

13. The method of claim 11, wherein trajectories of the merged object hypotheses predicted for a future point in time are compared to true trajectories of the merged object hypotheses determined at the future point in time to determine a prediction error, wherein the determined prediction error is propagated back to the encoder block, to the merging block and to the tracking block for training

14. The method of claim 11, wherein the prediction of the trajectories involves a transformer model, a recurrent neural network, or a graph neural network.

15. The method of claim 11, wherein the segmented raw data of an object hypothesis of a camera is converted into latent encodings with a convolutional neural network, wherein the weightings are learned in the convolutional neural network.

16. The method of claim 11, wherein the segmented raw sensor data of an object hypothesis of a Lidar sensor are converted into latent encodings with a PointNet, wherein the weightings in the PointNet are learned.

17. The method of claim 11, wherein for the learning-based formation of the merged object hypotheses, a paired measure of belonging is calculated between nodes in a graph, wherein a graph neural network is used for link prediction or edge classification, such that paired probabilities arise that nodes belong to a same object, wherein clusters of the individual nodes are formed based on the measure of belonging using a clustering algorithm.

18. The method of claim 11, wherein the learning-based formation of the merged object hypotheses uses a learned graph clustering algorithm.

19. The method of claim 11, wherein, for each of the learning-based clusters, information of all nodes is aggregated by pooling to produce, for each merged object hypothesis, an aggregated latent representation of the sensor data and an aggregated state.

20. The method of claim 17, wherein the formation of the tracking blocks uses a graph neural network for the link prediction or the edge classification.
